(19) United States
(12) Patent Application Publication
(10) Pub. No.: US 2026/0241776 A1
(43) Pub. Date: Aug. 20, 2026

(54) LAMINATED GLASS WINDOW SYSTEM, CAR BODY, AND TRACK-GUIDED VEHICLE FOR PASSENGER TRANSPORT

(71) Applicant: Siemens Mobility GmbH, München (DE)

(72) Inventor: Michael Schmäcke, Stolberg (DE)

(21) Appl. No.: 19/162,155

(22) PCT Filed: Feb. 29, 2024
(86) PCT No.: PCT/EP2024/055227

§ 371 Date: Sep. 4, 2025

(30) Foreign Application Priority Data
Mar. 24, 2023 (DE) 10 2023 202 699.6

(51) Int. Cl. B60J 1/02; B32B 7/08; B32B 7/12; B32B 17/10; B60J 1/00

(52) U.S. Cl. CPC B60J 1/02; B32B 7/08; B32B 7/12; B32B 17/10165; B60J 1/001; B32B 2605/00

(57) ABSTRACT

A laminated glass window system, in particular for a car body of a track-guided vehicle for passenger transport, includes a laminated glass pane and a frame for receiving the laminated glass pane. The frame including a first frame and a second frame. The laminated glass pane is connected to the first frame, and the second frame is releasably connected to the first frame. A car body and a track-guided vehicle are also provided.

The invention relates to a laminated glass window system for a track-guided vehicle for passenger transport.

The invention also relates to a car body comprising at least one such laminated glass window system.

Furthermore, the invention relates to a track-guided vehicle comprising at least one such laminated glass window system or such a car body.

Panes in track-guided vehicles such as, for example, rail vehicles or magnetic levitation trains, are often made of laminated glass panes.

In addition to at least two layers of glass, laminated glass panes have an additional layer, for example, made of plastic, cast resin or a highly tear-resistant, tough-elastic, thermoplastic composite film.

Side windows are usually attached to the car body by means of bonding. Specific environmental conditions and trained personnel are required for replacement. Curing times must also be taken into consideration. When using clamped windows, either the clamping rubber builds up on the car body or a recess is created. A method is known in which the windows are screwed into the car body and then the screw strip is covered with adhesive. To this end, threads are inserted into the side wall of the car body and the window frames have corresponding holes.

In the known solution described above, threads from screw connections were inserted into the side wall of the shell. It is difficult to maintain tight tolerances on account of the component dimensions. Faulty holes must be welded and recreated in the heat-affected zone.

When replacing a window, the bonded seal is cut out of the joint so that the window can be replaced. The adhesive must be removed from the screw heads to create space for the tool. If the corrosion protection layer of the car body is damaged while the bonded seal is being cut out, this can lead to corrosion on the car body and negatively affect the static equilibrium of the car.

Based on this, the object of the invention is to create a laminated glass window system of the type mentioned at the outset which permits easier replacement of a laminated glass pane.

This object is achieved according to the invention by the laminated glass window system as claimed in claim 1.

According to the invention, a laminated glass window system, in particular for a car body of a track-guided vehicle for passenger transport, is provided, comprising a laminated glass pane and a frame for receiving the laminated glass pane. The frame has a first frame and a second frame, and the laminated glass pane is connected to the first frame and the second frame is releasably connected to the first frame.

According to the invention, a car body, in particular for a track-guided vehicle for passenger transport, is also provided, comprising at least one such laminated glass window system or a laminated glass window system developed as described hereinafter, and at least one opening which is designed to receive the laminated glass window system.

Furthermore, according to the invention, a track-guided vehicle is provided, comprising at least one such laminated glass window system or a laminated glass window system developed as described hereinafter, or one such car body or a car body developed as described hereinafter.

The track-guided vehicle for passenger transport may preferably be a rail vehicle.

According to the invention, a laminated glass window system is provided which can be quickly replaced using simple means and by personnel who do not require any particular additional qualifications.

Furthermore, it may be provided that a laminated glass window is installed flush with the outer contour of the car body.

By contrast with an entire car body, small components such as the first frame and the second frame can be manufactured within narrow tolerances. In the event of defects or wear and tear, these components can be easily replaced.

It may be provided that the laminated glass panes can be arranged flush-mounted with the car body. Furthermore, the first frame may be arranged flush-mounted with the second frame. In addition, the second frame may be arranged flush-mounted with the car body.

The laminated glass window system is preferably arranged flush-mounted with the car body.

The first frame and the second frame can be designed in such a way that they extend to the outer contour of the car body and thus create a defined sealing surface which is independent of the contour of the car body and laminated glass pane components.

In a development of the laminated glass window system, it may be provided that the laminated glass pane is connected to the first frame in a material-locking manner, preferably by means of a first adhesive bond.

This provides a reliable connection between the laminated glass pane and the first frame, allowing the first frame together with the laminated glass pane to be designed as a module.

In a development of the laminated glass window system, a provision can be made for the second frame and the first frame to be connected via a plurality of form-and/or force-fitting connections, in particular screw connections.

The laminated glass pane can be inserted into the car body from outside with the first frame and is preferably attached to the second frame with screw connections.

This creates a connection between the first frame and the second frame which permits the first frame to be detached from the second frame without damage.

Compared to the machining of an entire car body, holes and threads with minimal deviations can also be added to the first frame and the second frame. In the event of defects or wear and tear, these components can be easily replaced.

According to the invention, it is possible to manufacture the first frame and the second frame precisely on a machining center with holes and threads. Machining is therefore much easier than on the car body, and inspection is possible beforehand. Even if the drilling pattern is imperfect, the first frame or the second frame can be easily replaced without costly repairs of the car body.

In a development of the laminated glass window system, it may also be provided that the first frame has a first extension area with a first contact surface and that the laminated glass pane is connected to the first contact surface of the first extension area in a material-locking manner.

This specifies a defined area and a reliable connection which are designed to connect the laminated glass pane to the first frame.

Furthermore, in an embodiment of the laminated glass window system it may be provided that the second frame has a third extension area with a third contact surface, and the third contact surface of the third extension area is designed for a material-locking connection, preferably with a second adhesive bond, to the car body.

This specifies a defined area and a reliable connection which are designed to connect the second frame to the car body.

In a development, the laminated glass window system may also provide that the first frame comprises a second extension area with a second contact surface and the second frame comprises a fourth extension area with a fourth contact surface, the second contact surface of the first frame resting on the fourth contact surface of the second frame with the interposition of a secondary seal.

This ensures that defined contact surfaces are formed between the first frame and the second frame. Furthermore, it is possible to form a secondary seal between these contact surfaces in order to reduce the possibility of water penetration.

The secondary seal is preferably designed as a surface seal.

Moreover, the laminated glass window system can provide that the plurality of releasable form-and/or force-fitting connections, in particular screw connections, are formed in the area of the second extension area of the first frame and the fourth extension area of the second frame.

This ensures that the releasable form-and/or force-fitting connections, in particular screw connections, are formed between the first frame and the second frame so that the car body is not impaired by the connections. In the event of wear and tear, it is possible to replace the first frame or the second frame.

Furthermore, in a development of the laminated glass window system, it may be provided that the first frame comprises a first side part with a second lateral surface and the second frame comprises a second side part with a fourth lateral surface, the second lateral surface of the first frame facing the fourth lateral surface of the second frame, and a primary seal being formed between the second lateral surface of the first frame and the fourth lateral surface of the second frame.

This specifies an arrangement which allows a primary seal between the first frame and the second frame. If the primary seal is to be removed, this is possible without adhesive residue being left on the screw head or damage being caused to the car body.

The primary seal can be glued between the fourth lateral surface of the second frame and the second lateral surface of the first frame. Bonding the primary seal to the car body is therefore no longer necessary.

Furthermore, in an embodiment of the laminated glass window system it may be provided that the first frame comprises a web and/or the first frame and the second frame each have a bead for providing a defined insertion depth for the primary seal.

Furthermore, the laminated glass window system may provide that the first frame comprises an L-shaped area which is formed from the first side part and the first extension area, the laminated glass pane being connected in a material-locking manner, preferably by a first adhesive bond, to the L-shaped area of the first frame.

This provides a defined area which is designed to receive the laminated glass pane and surrounds it, ensuring that the laminated glass pane is flush-mounted with the first frame.

It may also be provided that the second frame comprises an L-shaped area which is formed from the second side part and the third extension area, the L-shaped area being designed for a material-locking connection, preferably by means of the second adhesive bond, to the car body.

This provides a defined area which is designed to connect the second frame to the car body. The second frame is inserted flush-mounted into the corresponding opening of the car body.

Preferably, the first frame is an inner frame and the second frame is an outer frame.

In a development of the car body, it may be provided that the second frame comprises a third extension area with a third contact surface and the third contact surface of the third extension area is connected in a material-locking manner, preferably by a second adhesive bond, to the car body.

This specifies a defined contact surface for connecting the second frame to the car body, which enables the flush-mounted installation of the second frame in the car body.

Furthermore, in a development of the car body, it may be provided that the second frame comprises an L-shaped area which is formed from the second side part and the second extension area, the L-shaped area being connected in a material-locking manner, preferably by an adhesive bond, to the car body.

This defines a selected contact surface of the second frame, which on the one hand allows the second frame to be centered and on the other hand allows the second frame to be attached to the car body.

The invention is explained hereinafter with reference to several exemplary embodiments with regard to the diagram.

The diagram shows:

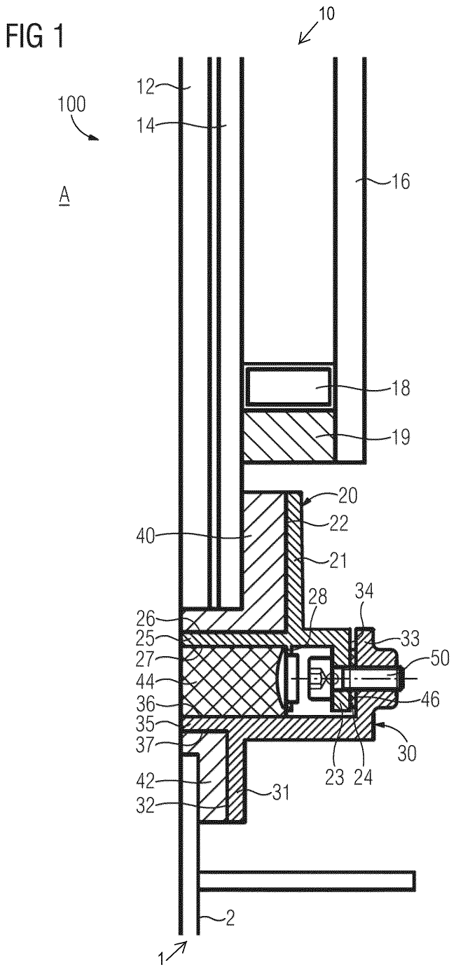

FIG. 1 A diagrammatic sectional view of the laminated glass window system according to a first embodiment in a state installed in a car body; and

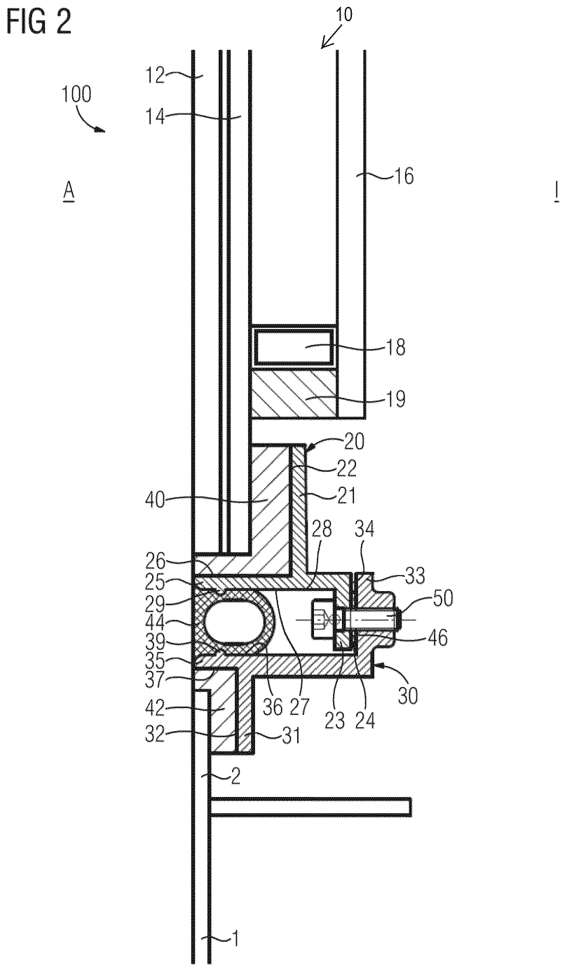

FIG. 2 A diagrammatic sectional view of the laminated glass window system according to a second embodiment in a state installed in a car body.

FIG. 1 shows a diagrammatic sectional view of the laminated glass window system 100 according to a first embodiment in a state installed in a car body 1.

The laminated glass window system 100 according to FIG. 1 is intended for a car body 1 of a track-guided vehicle for passenger transport.

The car body 1 is provided for a track-guided vehicle for passenger transport and comprises at least one laminated glass window system 100 and at least one opening which is designed to receive the laminated glass window system 100.

The track-guided vehicle comprises at least one laminated glass window system 100 and/or a car body 1 with such a laminated glass window system 100.

The car body 1 has a contact surface 2 for connecting the laminated glass window system 100 in the area of the opening.

The laminated glass window system 100 comprises a laminated glass pane 10 and a frame 20, 30 for receiving the laminated glass pane 10. The frame 20, 30 has a first frame 20 and a second frame 30, and the laminated glass pane 10 is connected to the first frame 20, and the second frame 30 is releasably connected to the first frame 20.

The first frame 20 is an inner frame and the second frame is an outer frame.

The laminated glass pane 10 is connected in a material-23 locking manner, preferably by a first adhesive bond 40, to the first frame 20.

As shown in FIG. 1, the laminated glass pane 100 preferably comprises three layers of glass 12, 14, 16. A first layer of glass 12 is an outer layer of glass, a second layer of glass 14 is an intermediate layer of glass and a third layer of glass 16 is an inner layer of glass.

The first layer of glass 12 is arranged on the outside of the vehicle A and the third layer of glass 16 is arranged on the inside of the vehicle I.

The first layer of glass 12 and the second layer of glass 14 are arranged in such a manner that they are connected to the first frame 20 by the adhesive bond 40.

The third layer of glass 16 is spaced further apart from the second layer of glass 14 than the first layer of glass 12. A spacer 18 is arranged between the second layer of glass 14 and the third layer of glass 16 to space apart the third layer of glass 16 from the second layer of glass 14. Furthermore, glass bonding 19 is formed between the second layer of glass 14 and the third layer of glass 19 in order to connect the third layer of glass 16 and the spacer 18 to the second layer of glass 14 in a material-locking manner.

The second frame 30 and the first frame 20 are connected via a plurality of form-and/or force-fitting connections 50, in particular screw connections.

The first frame 20 comprises a first extension area 21 with a first contact surface 22, and the laminated glass pane 10 is connected to the first contact surface 22 of the first extension area 21 in a material-locking manner.

The second frame 30 comprises a third extension area 31 with a third contact surface 32 and the third contact surface 32 of the third extension area 31 is designed for a material-locking connection, preferably with a second adhesive bond 42, to the car body 1.

In an embodiment of the car body 1, the third contact surface 32 of the third extension area 31 is connected with a material-locking connection, preferably with a second adhesive bond 42, to the car body 1.

The first frame 20 comprises a second extension area 23 with a second contact surface 24 and the second frame 30 comprises a fourth extension area 33 with a fourth contact surface 34. The fourth contact surface 24 of the first frame 20 rests on the fourth contact surface 34 of the second frame 30 with the interposition of a secondary seal 46.

The plurality of releasable form-and/or force-fitting connections 50, here screw connections, are formed in the area of the second extension area 23 of the first frame 20 and the fourth extension area 33 of the second frame 30.

Sealing by means of an adhesive is also possible. For this, the screw heads of the screw connection 50 are protected from the adhesive by a web 28. The web 28 has openings above the screw connection 50 which are closed before bonding by means of the primary seals 44 (covering caps).

The first frame 20 comprises a first side part 25 with a first lateral surface 26 and a second lateral surface 27, and the second frame 30 comprises a second side part 35 with a third lateral surface 36 and a fourth lateral surface 37. The second lateral surface 27 of the first frame 20 faces the fourth lateral surface 37 of the second frame 30, and a primary seal 44 is formed between the second lateral surface 27 of the first frame 20 and the fourth lateral surface 37 of the second frame 30.

A seal profile is inserted as the primary seal 44 into the gap between the second frame 30, which is connected to the car body 1, and the first frame 20, which is connected to the laminated glass pane. The primary seal 44 is flush-mounted with the car body 1 but can also be concave or convex in design. The seal compensates for tolerances in the x, y and z directions.

The first frame 20 comprises the web 28 for providing a defined insertion depth for the primary seal 44.

The first frame 20 comprises an L-shaped area 21, 25 which is formed from the first side part 25 and the first extension area 21. The laminated glass pane 10 is connected in a material-locking manner, preferably by a first adhesive bond 40, to the L-shaped area 21, 25 of the first frame 20.

The second frame 30 comprises an L-shaped area 31, 35 which is formed from the side part 35 and the first extension area 31. The L-shaped area is designed for a material-locking connection, preferably by means of the second adhesive bond 42, to the car body 1.

In an embodiment of the car body 1, the second frame 30 comprises the L-shaped area 31, 35 which is formed of the second side part 35 and the third extension area 31, the L-shaped area being connected in a material-locking manner, preferably by a second adhesive bond 42, to the car body 1. The first frame 20 and the second frame 30 can be designed in such a manner that they extend to the outer contour of the car body 1 and thereby create a defined sealing surface which is independent of the contour of the car body 1 and laminated glass pane 10 components. The laminated glass pane 10 is inserted from the outside into the opening of the car body 1 with the first frame 20 and is fastened in the second frame 30 by means of screws 50.

FIG. 2 shows a diagrammatic sectional view of the laminated glass window system 100 according to a second embodiment in a state installed in a car body 1. The laminated glass window system 100 according to the second embodiment is based on the laminated glass window system 100 of the first embodiment and only the differences between the laminated glass window system 100 of the second embodiment and the laminated glass window system 100 of the first embodiment are described hereinafter.

Unlike the laminated glass window system 100 according to the first embodiment, the laminated glass window system 100 according to the second embodiment does not have a web 28.

The laminated glass window system 100 according to the second embodiment comprises a first frame 20 and a second frame 30, each of which has a bead 29, 39 for providing a defined insertion depth for the primary seal 44. Preferably, the beads 29, 39 are formed opposite one another on the side parts 25, 35 of the first frame 20 and the second frame 30. The primary seal 44 may have a recess corresponding to the shape of the beads 29, 39 so that the primary seal 44 can be locked into its final position by the beads 29, 39.

The above disclosure applies equally to the car body 1 described above, comprising at least one laminated glass window system 100 as described above.

The above disclosure applies equally to a track-guided vehicle, comprising at least one laminated glass window system 100 as described above, or a car body 1 as described above.

Finally, it should be mentioned that the features of all the embodiment variants described above can be combined with one another in any manner in order to form further different exemplary embodiments of the invention. Also, all the features of subclaims can be combined with each feature of any other claim, either individually or in any combination, in order to obtain further different exemplary embodiments.

Although the invention has been illustrated and described in detail by an exemplary embodiment, the invention is not limited by the disclosed examples and other variations may be derived therefrom by a person skilled in the art without departing from the scope of the invention.

Independent of the grammatical term usage, individuals with male, female or other gender identities are included within the term.

1-16. (canceled)

17. A laminated glass window system or a laminated glass window system for a car body of a track-guided vehicle for passenger transport, the laminated glass window system comprising:
a laminated glass pane and a frame for receiving said laminated glass pane;
said frame including a first frame and a second frame;
said laminated glass pane being connected to said first frame, and said second frame being releasably connected to said first frame.

18. The laminated glass window system according to claim 17, wherein said laminated glass pane is connected in a material-locking manner to said first frame.

19. The laminated glass window system according to claim 17, wherein said laminated glass pane is connected by an adhesive bond to said first frame.

20. The laminated glass window system according to claim 17, wherein said first frame includes a first extension area with a first contact surface, and said laminated glass pane is connected in a material-locking manner to said first contact surface of said first extension area.

21. The laminated glass window system according to claim 17, wherein said second frame and said first frame are connected by a plurality of at least one of form-locking or force-locking connections.

22. The laminated glass window system according to claim 21, wherein said connections are screw connections.

23. The laminated glass window system according to claim 17, wherein said second frame includes a third extension area with a third contact surface, and said third contact surface of said third extension area is configured for a material-locking connection to the car body.

24. The laminated glass window system according to claim 23, wherein said material-locking connection is an adhesive bond.

25. The laminated glass window system according to claim 17, wherein said first frame includes a second extension area with a second contact surface, said second frame includes a fourth extension area with a fourth contact surface, and said second contact surface of said first frame rests on said fourth contact surface of said second frame with an interposition of a secondary seal.

26. The laminated glass window system according to claim 25, wherein said second frame and said first frame are connected by a plurality of at least one of form-locking or force-locking connections formed in an area of said second extension area of said first frame and said fourth extension area of said second frame.

27. The laminated glass window system according to claim 26, wherein said connections are screw connections.

28. The laminated glass window system according to claim 17, wherein said first frame includes a first side part with a second lateral surface, and said second frame includes a second side part with a fourth lateral surface, said second lateral surface of said first frame faces said fourth lateral surface of said second frame, and a primary seal is formed between said second lateral surface of said first frame and said fourth lateral surface of said second frame.

29. The laminated glass window system according to claim 28, wherein said first frame includes a web for providing a defined insertion depth for said primary seal.

30. The laminated glass window system according to claim 28, wherein said first frame and said second frame each have a respective bead for providing a defined insertion depth for said primary seal.

31. The laminated glass window system according to claim 28, wherein:
said first frame includes a first extension area;
said first frame has an L-shaped area formed from said first side part and said first extension area; and
said laminated glass pane is connected in a material-locking manner to said L-shaped area of said first frame.

32. The laminated glass window system according to claim 31, wherein said material-locking connection is formed by an adhesive bond.

33. The laminated glass window system according to claim 28, wherein:
said second frame includes a third extension area;
said second frame includes an L-shaped area formed from said second side part and said third extension area; and
said L-shaped area is configured for a material-locking connection to the car body.

34. The laminated glass window system according to claim 33, wherein said material-locking connection is formed by an adhesive bond.

35. The laminated glass window system according to claim 17, wherein said first frame is an inner frame and said second frame is an outer frame.

36. A car body or a car body for a track-guided vehicle for passenger transport, the car body comprising:
at least one laminated glass window system according to claim 17; and
at least one opening configured to receive the at least one laminated glass window system.

37. The car body according to claim 36, wherein said second frame includes a third extension area with a third contact surface, and said third contact surface of said third extension area is connected in a material-locking manner to the car body.

38. The car body according to claim 37, wherein said material-locking connection is formed by an adhesive bond.

39. The car body according to claim 37, wherein:
said second frame includes a second side part;
said second frame includes an L-shaped area formed from said second side part and said third extension area; and
said L-shaped area is connected in a material-locking manner to the car body.

40. The car body according to claim 39, wherein said material-locking connection is formed by an adhesive bond.

41. A track-guided vehicle, comprising at least one laminated glass window system according to claim 17.

42. A track-guided vehicle, comprising at least one car body according to claim 36.
